(19) United States
(12) Patent Application Publication
(10) Pub. No.: US 2010/0029248 A1
(43) Pub. Date: Feb. 4, 2010

(54) METHOD, APPARATUS AND SYSTEM FOR MANAGING USER ACCESS TO NETWORK

(75) Inventors: Shufeng SHI, Shenzhen (CN); Xuexia YAN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/510,682

(22) Filed: Jul. 28, 2009

(30) Foreign Application Priority Data
Jul. 29, 2008 (CN) 200810142564.3

(51) Int. Cl. H04M 1/66

(52) U.S. Cl. 455/411

(57) ABSTRACT

The present disclosure discloses a method, an apparatus and a system for managing user access to a network. The method includes: carrying, by a mobile management apparatus, in a location update request a radio access type currently used by a user; and determining, by an access restriction management apparatus in accordance with the received radio access type currently used by the user and access restriction subscription data of the user stored therein, whether the user is allowed to get access to the network through the currently used access type, and, when it is determined the access is not allowed, directly returning a location update failure response to the mobile management apparatus, thereby avoiding unnecessary signaling load between the mobile management apparatus and one of an HLR and an HSS.

### CROSS-REFERENCE TO RELATED APPLICATIONS

This application claims priority to Chinese Patent Application No. 200810142564.3, filed Jul. 29, 2008, the entire contents of which are hereby incorporated in its entirety.

### FIELD OF THE TECHNOLOGY

The present disclosure relates to the technical field of communications, and more particularly to a method, an apparatus and a system for managing user access to a network.

### BACKGROUND OF THE DISCLOSURE

Currently, available networks of circuit domain and packet domain can provide management for user access restriction. In a home location register (HLR), it is possible to store access restriction subscription data, values of which include “GSM/EDGE Radio Access Network (GERAN) Not Allowed” and “UMTS Terrestrial Radio Access Network (UTRAN) Not Allowed”, indicating whether the corresponding accesses are allowed to be used to get access to the network, respectively. In System Architecture Evolution (SAE), it is possible to provide restriction management of many more radio access types. Access restriction subscription data that may be stored in a home subscriber server (HSS) includes “UTRAN Not Allowed”, “GERAN Not Allowed”, “Generic Access Network (GAN) Not Allowed”, “Internet-High Speed Packet Access-Evolution (I-HSPA-Evolution) Not Allowed”, “Evolved UMTS Terrestrial Radio Access Network (E-UTRAN) Not Allowed”, and “Handover-To-Non-3GPP-Access (HO-To-Non-3GPP-Access) Not Allowed.”

When a user registers or attaches via the C/D interface between a Mobile Switch Center/Visit Location Register (MSC/VLR) and an HLR, via the Gr interface between a Serving GPRS Supporting Node (SGSN) and an HLR, and via an S6a interface between a Mobility Management Entity (MME) and an HSS, the HLR or HSS determines whether it is necessary to restrict access of the user to the network in accordance with radio access types supported (Supported RAT Types) by a mobile management apparatus (the MSC/VLR, SGSN or MME is collectively referred to herein as the mobile management apparatus) together with the stored access restriction subscription data of the user. For instance, if the radio access types supported by the mobile management apparatus are UTRAN, GERAN and E-UTRAN, whereas the access restriction subscription data is “E-UTRAN Not Allowed”, the HSS will consider that the access restriction subscription data of the user is different from the radio access types supported by the mobile management apparatus, and that it is unnecessary to restrict access of the user to the network, and instead return subscription data of the user. However, the radio access types supported by the mobile management apparatus may not be equivalent to the radio access type currently used by the user.

Consequently, the following problem exists in the conventional art: in the circumstance where the mobile management apparatus supports a plurality of access types, and the radio access type currently used by the user is supported by the mobile management apparatus, but it is not allowed as subscribed in the access restriction subscription data in an HLR or HSS for the user to use this access type, the HLR or HSS will still return subscription data of the user to the mobile management apparatus, thereby causing unnecessary signaling load between the mobile management apparatus and the HLR or HSS.

### SUMMARY OF THE DISCLOSURE

A main objective of the present disclosure is to provide a method, an apparatus and a system for managing user access to a network, so as to eliminate the problem in the conventional art that, when the radio access type currently used by the user is supported by the mobile management apparatus, but it is not allowed as subscribed in the access restriction subscription data in an HLR or HSS for the user to use this access type to get access to a network, the HLR or HSS will still return subscription data of the user to the mobile management apparatus, thereby causing unnecessary signaling load.

In order to achieve the above objective, embodiments of the present disclosure provide the following technical solutions.

A method for managing user access to a network includes: (1) receiving a location update request carrying a radio access type currently used by a user sent from a mobile management apparatus; and (2) determining, in accordance with the radio access type currently used by the user, whether the user is allowed to get access to a network through the currently used radio access type, and returning a location update failure response if the user is not allowed to get access to the network.

An access restriction management apparatus includes: (1) a request receiving unit, adapted to receive a location update request carrying a radio access type currently used by a user sent from a mobile management apparatus; (2) a storing unit, adapted to store access restriction subscription data of the user; (3) a managing unit, adapted to: check the access restriction subscription data of the user stored in the storing unit in accordance with the radio access type currently used by the user as received by the request receiving unit, and determine whether the user is allowed to get access to a network through the currently used radio access type; and (4) a first processing unit, adapted to return a location update failure response to the mobile management apparatus in the case where the managing unit determines that the user is not allowed to get access to the network through the currently used radio access type.

A communication system for executing location update includes: (1) a mobile management apparatus, adapted to transmit a location update request carrying a radio access type currently used by a user; and (2) a home location register (HLR) or a home subscriber server (HSS), adapted to: receive the location update request carrying the radio access type currently used by the user; determine, in accordance with the radio access type currently used by the user, whether the user is allowed to access to a network through the currently used radio access type; and directly return a location update failure response if the result of the determination is “NOT.”

A communications system for executing location update includes: (1) a mobile management apparatus, adapted to transmit a location update request carrying a radio access type currently used by a user; and (2) an inter-working function (IWF), adapted to determine whether the user is allowed to get access to a network through the currently used radio access type when the IWF judges that the IWF has stored access restriction subscription data of the user about the currently used radio access type, and return a location update failure response if the result of the determination is “NOT.”

In the method provided in the embodiment of the present disclosure, the mobile management apparatus carries the radio access type currently used by the user in the location update request, and the access restriction management apparatus determines whether to allow the user to get access to the network through the currently used access type in accordance with the received radio access type currently used by the user and access restriction subscription data of the user stored in itself, and directly returns a location update failure response to the mobile management apparatus when it is determined that access is not allowed, thereby avoiding unnecessary signaling load between the mobile management apparatus and the HLR or HSS.

### BRIEF DESCRIPTION OF THE DRAWINGS

Accompanying drawings as explained herein are provided to facilitate further comprehension of the present disclosure, and constitute a part of the application, but are not restrictive of the present disclosure. In the drawings:

FIG. 1 is a schematic diagram illustrating the flowchart according to a First Method Embodiment of the disclosure;

FIG. 2 is a schematic diagram illustrating the flowchart according to a Second Method Embodiment of the disclosure;

FIG. 3 is a schematic diagram illustrating the flowchart according to a Third Method Embodiment of the disclosure;

FIG. 4 is a schematic diagram illustrating the flowchart according to a Fourth Method Embodiment of the disclosure;

FIG. 5 is a block diagram illustrating the configuration according to a First Apparatus Embodiment of the disclosure;

FIG. 6 is a block diagram illustrating the configuration according to a Second Apparatus Embodiment of the disclosure;

FIG. 7 is a block diagram illustrating the configuration according to a First System Embodiment of the disclosure; and

FIG. 8 is a block diagram illustrating the configuration according to a Second System Embodiment of the disclosure.

### DETAILED DESCRIPTION OF THE EMBODIMENTS

To make the objectives, technical solutions and advantages of the present disclosure more apparent, embodiments of the present disclosure are described further in details below with reference to the accompanying drawings and specific examples.

### First Method Embodiment of the Disclosure

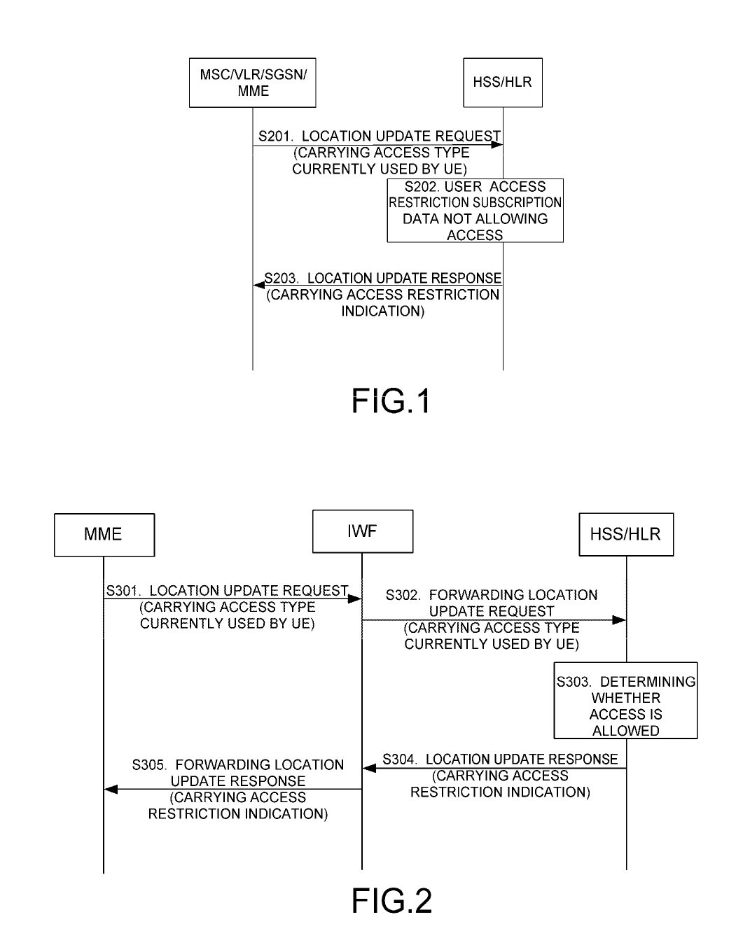

As shown in FIG. 1, a mobile management apparatus (MSC/VLR, SGSN, MME) in the First Method Embodiment transmits the radio access type (RAT) currently used by a user in a location update request to an HLR or HSS, and the HLR or HSS directly determines whether the user is allowed to get access to the network through the currently used radio access type. The process of managing the user access to a network in the First Method Embodiment is described as follows.

In step S201, the mobile management apparatus transmits the location update request to the HLR or HSS.

When a User Equipment used by the user is powered on, attach process for getting access to the network is triggered. Alternatively, the departure of the user from the radio coverage managed by the mobile management apparatus originally attached will trigger attach procedure or routing area update procedure or tracking area update procedure. At this time, the mobile management apparatus transmits the location update request to the HLR or HSS with a newly added access type parameter carrying the radio access type currently used by the user. A data type of the newly added access type parameter may be integer type or enumeration type or character string type, and may also be other data types. The data type of the newly added access type parameter indicates the radio access type currently used by the user. The First Method Embodiment mainly exemplifies the circumstance in which the user uses a radio access type not subscribed to get access to the network, including: a) the user having only subscribed with GERAN access gets access to the circuit Switched domain network through UTRAN access, and an MSC/VLR transmits a location update request to the HLR, wherein the radio access type of the user carried in the location update request is indicated as UTRAN; or b) the user having only subscribed with GERAN access gets access to the packet Switched domain network through UTRAN access, and the SGSN transmits a location update request to the HLR, wherein the radio access type of the user carried in the location update request is indicated as UTRAN; or c) the user having only subscribed with UTRAN access gets access to the LTE network through E-UTRAN access, and an MME transmits a location update request to the HSS, wherein the radio access type of the user carried in the location update request is indicated as E-UTRAN. It is not intended to enumerate all specific application scenarios of this embodiment in the above way, and other application scenarios will not be described in detail herein.

In step S202, the HLR or HSS checks access restriction subscription data of the user stored in the HLR or HSS itself in accordance with the received radio access type currently used by the user, and determines whether the user is allowed to get access to the network through the currently used radio access type.

Corresponding to the three application scenarios in step S201, step S202 specifically may be: a) the HLR checks the access restriction subscription data of the user upon receiving the location update request and finds that the user is not allowed to get access to the network through the currently used radio access type UTRAN; b) the HLR checks the access restriction subscription data of the user upon receiving the location update request and finds that the user is not allowed to get access to the network through the currently used radio access type UTRAN; c) the HSS checks the access restriction subscription data of the user upon receiving the location update request and finds that the user is not allowed to get access to the network through the currently used radio access type E-UTRAN.

In step S203, the HLR or HSS returns a location update failure response to the mobile management apparatus.

The location update failure response may carry an access restriction indicator to indicate the cause of the failure, and the access restriction indicator can reuse the existing failure indicator, such as “Roaming not Allowed due to Access Restriction”, and can also use a new failure indicator to specify “Access Type not Allowed.”

It should be noted that, if in step S202 the HLR or HSS determines that the user is allowed to get access to the network through the currently used radio access type, the access restriction subscription data of the user will be returned to the mobile management apparatus.

As described in the First Method Embodiment of the disclosure, the mobile management apparatus (MSC/VLR, SGSN or MME) transmits the radio access type currently used by the user in the location update request to the HLR or HSS, and the HLR or HSS directly determines whether the user is allowed to get access to the network through the currently used radio access type. In the case where the user is not allowed to get access to the network, the HLR or HSS directly returns the location update failure response to the MSC/VLR, SGSN or MME, so that it is avoided to initiate insertion of access restriction subscription data of the user or to carry the access restriction subscription data of the user in the location update response, and the access restriction subscription data of the user will not be returned to the mobile management apparatus, thereby avoiding unnecessary signaling load.

### Second Method Embodiment of the Disclosure

During the process of network evolution, the Evolved Packet Service (EPS) network will coexist with the General Packet Radio Service (GPRS) network for a certain period of time. Since the S6a interface between an MME and an HSS in the EPS network uses Diameter protocol, while the Gr/Gr+ interface between an SGSN and an HSS/HLR in the GPRS network uses MAP protocol, in order for GPRS users to roam to the EPS network to get access to and use services therein without affecting the GPRS network being greatly commercialized already, an Inter-working Function (IWF) network element is added between the MME and the HSS/HLR that supports only the Gr/Gr+ interface. The application scenario in the Second Method Embodiment of the disclosure is the scenario where the EPS network inter-works with the GPRS network. As shown in FIG. 2, management process of user access to a network in the Second Method Embodiment is described as follows.

In step S301, a user having only subscribed with UTRAN access gets access to the LTE network via E-UTRAN, and an MME transmits a location update request based on the Diameter protocol to an IWF, whereby the radio access type E-UTRAN currently used by UE can be carried by newly adding an access type parameter in the location update request as in the First Embodiment. In this step, the MME actually transmits the location update request to the HSS, but the request is firstly received by the IWF.

In step S302, upon receiving the location update request, the IWF converts it into a location update request based on the MAP protocol, and transmits the converted location update request to the HSS or HLR.

In step S303, the HSS or HLR checks subscription data of the user to determine whether the user is allowed to get access to the network through the currently used radio access type and finds that the user is not allowed to get access to the network through E-UTRAN.

In step S304, the HSS or HLR returns a location update failure response to the IWF. The location update failure response carries an access restriction indicator to indicate the cause of the failure, and the access restriction indicator can reuse the existing failure indication, such as “Roaming not Allowed due to Access Restriction”, and can also use a new failure indicator to specify “Access Type not Allowed.”

In step S305, the IWF converts the location update failure response based on the MAP protocol into a location update response based on the Diameter protocol and transmits the converted location update failure response to the MME.

It should be noted that, if the HSS or HLR determines that the user is allowed to get access to the network through the currently used radio access type in Step S303, the HSS or HLR will return the subscription data of the user to the IWF, and the IWF forwards the subscription data to the mobile management apparatus.

The Second Method Embodiment of the disclosure is applicable to the application scenario in which the EPS inter-works with the HSS or the HLR of Rel-8 or pre Rel-8, wherein the MME transmits the radio access type currently used by the user to the HSS or HLR in the location update request, and the HSS or HLR directly determines whether the user is allowed to get access to the network through the currently used radio access type. In the case where the user is not allowed to get access to the network, the HLR or HSS directly returns the location update failure response to the MME, so that it is avoided to initiate insertion of access restriction subscription data of the user or to carry the access restriction subscription data of the user in the location update response, thereby avoiding unnecessary signaling load.

### Third Method Embodiment of the Disclosure

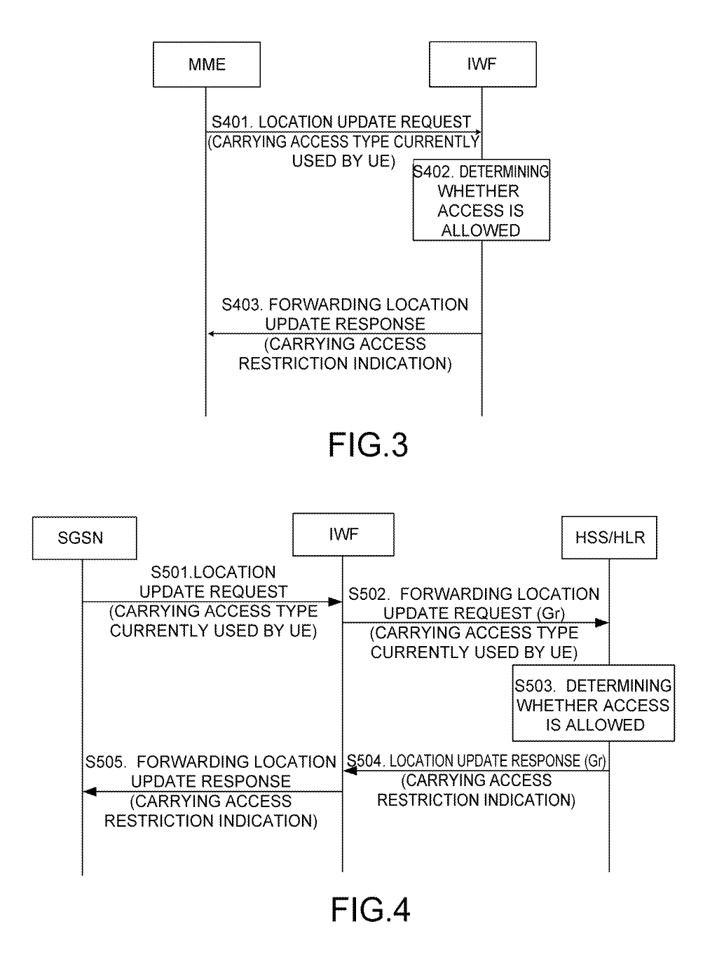

As shown in FIG. 3, in the application scenario of the Third Method Embodiment of the disclosure, like that of the Second Method Embodiment, access restriction subscription data of the user concerning E-UTRAN or other radio access types than GERAN or UTRAN is placed on an IWF in order not to affect an HSS or HLR of pre Rel-8. Management process of user access to a network in the Third Method Embodiment is described as follows.

In step S401, a user having only subscribed with UTRAN access gets access to the LTE network via E-UTRAN, and an MME transmits a location update request based on the Diameter protocol to an IWF. The MME actually transmits the location update request to the HSS, but the request is firstly received by the IWF. The radio access type currently used by UE, i.e., E-UTRAN, is carried in the location update request. The mode of carrying the parameter is identical with that in the First Method Embodiment.

In step S402, upon receiving the location update request, the IWF determines that the radio access type currently used by the user is E-UTRAN, and hence determines that it has stored the access restriction subscription data of the radio access type E-UTRAN currently used by the user, so that it directly checks the subscription data of the user to determine whether the user is allowed to get access to the network through the currently used radio access type, and finds that the user is not allowed to get access to the network through E-UTRAN.

In step S403, the IWF returns a location update failure response to the MME. The location update failure response carries an access restriction indicator to indicate the cause of the failure, and the access restriction indicator can reuse the existing failure indicator, such as “Roaming not Allowed due to Access Restriction”, and can also use a new failure indicator to specify “Access Type not Allowed.”

It should be noted that, if the IWF determines that the user is allowed to get access to the network through the currently used radio access type in Step S402, the IWF converts the location update request into a message based on the MAP protocol and forward the converted messaged to the HSS or HLR, the HSS or HLR returns the subscription data of the user, and the IWF forwards the subscription data of the user returned by the HSS or HLR to the MME.

The Third Method Embodiment of the present disclosure is applicable to the application scenario in which the EPS inter-works with the HSS or HLR of Rel-8 or pre Rel-8. Different from the Second Method Embodiment, such information as access restriction subscription data of the user is placed on the IWF, which directly determines whether the user is allowed to get access to the network through the currently used radio access type, and directly returns a failure response to the MME in the case where access is not allowed, thus avoiding information interaction with HSS or HLR to thereby avoid unnecessary signaling load.

### Fourth Method Embodiment of the Disclosure

With evolution of the network, the interface between an SGSN and an HSS or HLR in the EPS network gradually evolves from MAP-based Gr to Diameter-based S6d. In order to achieve inter-working like that in the Third Method Embodiment, namely to enable GPRS users to roam to the EPS network to get access to and use services in the EPS network, an inter-working function (IWF) network element is also added between an SGSN that supports Diameter and an HSS or HLR that only supports the Gr/Gr+ interface, as shown in FIG. 4. In order not to affect the HLR of pre Rel-8, user access restriction subscription data concerning E-UTRAN or other radio access types than GERAN or UTRAN is placed on the IWF. Management process of user access to network through GERAN in this Embodiment is described as follows.

In step S501, a user having only subscribed with E-UTRAN access gets access to the LTE network via GERAN, and the SGSN transmits a location update request based on the Diameter protocol to the IWF (HSS). The radio access type currently used by UE, i.e., GERAN, is carried in the location update request. The mode of carrying the parameter is identical with that in the First Embodiment.

In step S502, upon receiving the location update request, the IWF determines that the radio access type currently used by the user is not E-UTRAN or other radio access types than GERAN or UTRAN, and hence determines that it has not stored the access restriction subscription data of the radio access type currently used by the user, i.e., GERAN, so that the IWF converts the message into a location update request based on the MAP protocol and transmits it to the HSS or HLR.

In step S503, the HSS or HLR checks the subscription data of the user to determine whether the user is allowed to get access to the network through the currently used radio access type, and finds that the user is not allowed to get access to and use the network through GERAN.

In step S504, the HSS or HLR returns a location update failure response to the IWF. The location update failure response carries an access restriction indicator to indicate the cause of the failure, and the access restriction indicator can reuse the existing failure indication, such as “Roaming not Allowed due to Access Restriction”, and can also use a new failure indicator to specify “Access Type not Allowed.”

In step S505, upon converting the location update failure response based on the MAP protocol into a location update response based on the Diameter protocol, the IWF transmits the converted message to the SGSN.

It should be noted that, if the HSS or HLR determines that the user is allowed to get access to the network through the currently used radio access type in Step S503, the HSS or HLR will return the subscription data of the user to the IWF, and the IWF forwards the data to the mobile management apparatus.

The Fourth Method Embodiment of the present disclosure is applicable to the application scenario in which the EPS inter-works with the HSS/HLR of pre Rel-8 or Rel-8 not supporting the Diameter-based S6d interface. Unlike the Third Method Embodiment, if the radio access type currently used by the user is GERAN or UTRAN, it is still the HSS/HLR that determines whether the user is allowed to get access to the network through the currently used radio access type, and in the case where access is not allowed, the IWF directly returns the failure response to the SGSN, thus avoiding information interaction with HSS/HLR to thereby avoid unnecessary signaling load.

### First Apparatus Embodiment of the Disclosure

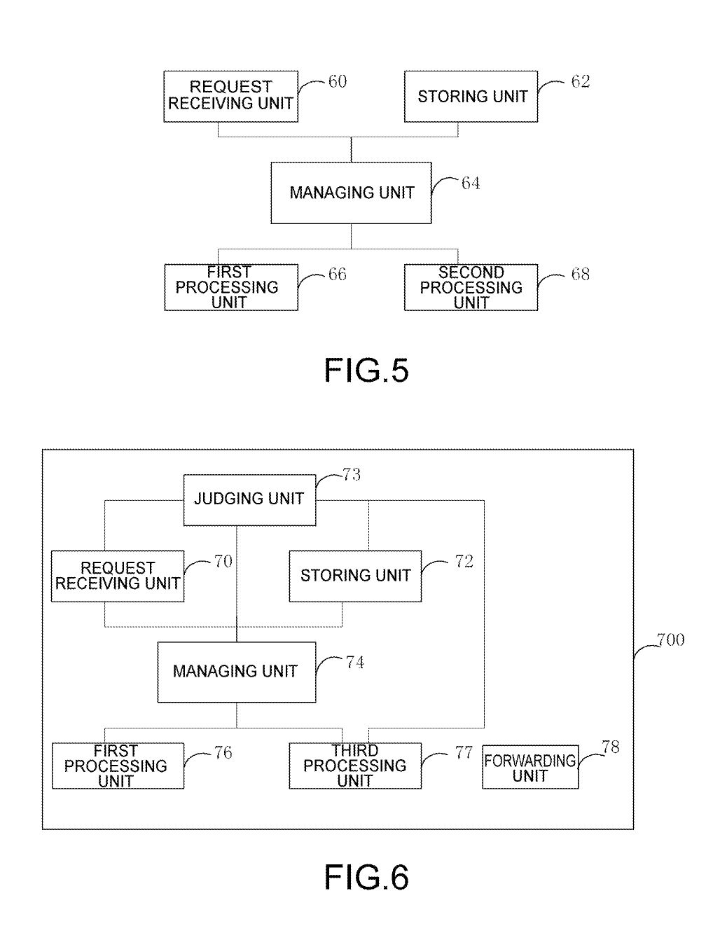

As shown in FIG. 5, an access restriction management apparatus as provided in the embodiment of the present disclosure includes: (1) a request receiving unit 60, adapted to receive a location update request carrying a radio access type currently used by a user sent from a mobile management apparatus; (2) a storing unit 62, adapted to store access restriction subscription data of the user. In this embodiment, the storing unit 62 is adapted to store subscription data of the user, where subscription data of the user includes access restriction subscription data of the user concerning the currently used radio access type; (3) a managing unit 64, adapted to check the access restriction subscription data of the user stored in the storing unit 62 in accordance with the radio access type currently used by the user as received by the request receiving unit 60, and determine whether the user is allowed to get access to a network through the currently used radio access type; (4) a first processing unit 66, adapted to directly return a location update failure response, which carries an access restriction indicator to indicate the cause of the failure of the location update, in the case that the managing unit 64 determines that the user is not allowed to get access to the network through the currently used radio access type; and (5) a second processing unit 68, adapted to return the subscription data of the user stored in the storing unit 62 to the mobile management apparatus in the case that the managing unit 64 determines that the user is allowed to get access to the network through the currently used radio access type.

The access restriction management apparatus provided by this embodiment may be an HSS or HLR, and the mobile management apparatus that sends the location update request may be an MSC/VLR, SGSN or MME. The access restriction management apparatus directly determines whether the user is allowed to get access to the network through the currently used radio access type in accordance with the received radio access type currently used by the user, and in the case that the access is not allowed, directly returns the location update failure response, so that it is avoided to initiate insertion of access restriction subscription data of the user or to carry the access restriction subscription data of the user in the location update response, thereby avoiding unnecessary signaling load.

### Second Apparatus Embodiment of the Disclosure

As shown in FIG. 6, an access restriction management apparatus 700 as provided in the embodiment of the present disclosure includes: (1) a request receiving unit 70, adapted to receive a location update request carrying a radio access type currently used by the user sent from a mobile management apparatus; (2) a storing unit 72, adapted to store access restriction subscription data of the user—what is stored in this embodiment is mainly access restriction subscription data of the user concerning E-UTRAN or other radio access types than GERAN and UTRAN, which is part of the access restriction subscription data of the user; (3) a judging unit 73, adapted to determine whether the storing unit 72 has stored the access restriction subscription data of the radio access type currently used by the user as received by the request receiving unit 70; (4) a managing unit 74, adapted to: check, when the judging unit 73 determines that it has stored the access restriction subscription data of the radio access type currently used by the user as received by the request receiving unit 70, the access restriction subscription data of the user in the storing unit 72 in accordance with the radio access type currently used by the user; and determine whether the user is allowed to get access to the network through the currently used radio access type; (5) a first processing unit 76, adapted to directly return a location update failure response, which carries an access restriction indicator to specify the cause of the failure of the location update, when the managing unit 74 determines that the user is not allowed to get access to the network through the currently used radio access type; (6) a third processing unit 77, adapted to forward the location update request carrying the radio access type currently used by the user as received by the request receiving unit 70 to the HLR or HSS when the managing unit 74 determines that the user is allowed to get access to the network through the currently used radio access type, or when the judging unit 73 determines that the storing unit 72 has not stored the access restriction subscription data of the radio access type currently used by the user as received by the request receiving unit 70, so that the HLR or HSS determines whether the user is allowed to get access to the network through the currently used radio access type in accordance with the radio access type currently used by the user as received (since the storing unit in this embodiment stores part of user access restriction subscription data, when the judging unit 73 determines that the storing unit 72 has not stored the access restriction subscription data of the radio access type currently used by the user as received by the request receiving unit 70, the location update request can be forwarded to the HLR or HSS, and since the HLR or HSS stores the remaining part of user access restriction subscription data, the step of determining whether the access is allowed can be continued), and carries out operations in accordance with the result of the determination: returning a location update failure response when it is determined that the user is not allowed to get access to the network through the currently used radio access type, and returning the subscription data when it is determined that the user is allowed to get access to the network through the currently used radio access type; and (7) a forwarding unit 78, adapted to forward, upon receiving subscription data of the user or location update failure response sent from the HLR or HSS, the subscription data of the user or the location update failure response to the mobile management apparatus with conversion from the MAP protocol to the Diameter protocol.

The access restriction management apparatus provided by this embodiment may be an IWF, and the mobile management apparatus that sends the location update request may be an MSC/VLR, SGSN or MME. The access restriction management apparatus directly determines whether the user is allowed to get access to the network through the currently used radio access type in accordance with the received radio access type currently used by the user, and in the case that the access is not allowed, directly returns the failure response, so that information interaction with the HLR is avoided, thereby avoiding unnecessary signaling load.

### First System Embodiment of the Disclosure

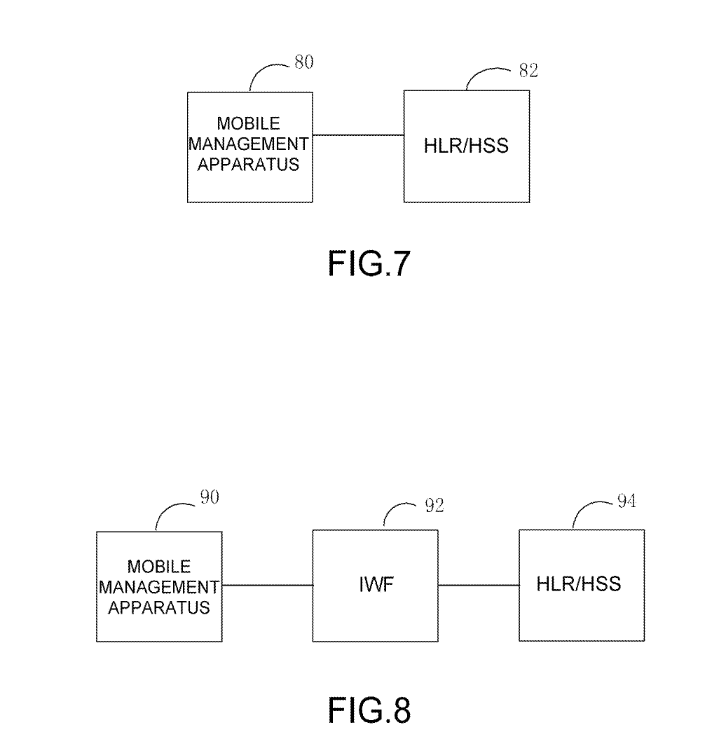

As shown in FIG. 7, a communication system for executing location update provided by the embodiment of the present disclosure includes: (1) a mobile management apparatus 80, adapted to transmit a location update request carrying a radio access type currently used by a user; and (2) a home location register (HLR) or a home subscriber server (HSS) 82, adapted to: receive the location update request carrying the radio access type currently used by the user; determine, in accordance with the radio access type currently used by the user, whether the user is allowed to get access to the network through the currently used radio access type; and, if not, directly return a location update failure response.

### Second System Embodiment of the Disclosure

As shown in FIG. 8, a communication system for executing location update provided by the embodiment of the present disclosure includes: (1) a mobile management apparatus 90, adapted to transmit a location update request carrying a radio access type currently used by a user; and (2) an inter-working function (IWF) 92, adapted to: determine whether the user is allowed to get access to the network through the currently used radio access type when the IWF judges that the IWF has stored access restriction subscription data of the user concerning the currently used radio access type; and if not, directly return a location update failure response.

When the IWF judges that the IWF has not stored access restriction subscription data of the user concerning the currently used radio access type, the IWF is further adapted to forward the location update request carrying the radio access type currently used by the user.

The communication system further includes: a home location register (HLR) or a home user server (HSS) 94, adapted to: receive the location update request carrying the radio access type currently used by the user as forwarded by the IWF; determine, in accordance with the radio access type currently used by the user, whether the user is allowed to access to the network through the currently used radio access type; and, if not, directly return a location update failure response.

In the access restriction management system provided by this embodiment, the mobile management apparatus sends the location update request carrying the radio access type currently used by the user, and the HLR or the HSS or the IWF directly determines whether the user is allowed to get access to the network through the currently used radio access type in accordance with the received radio access type currently used by the user, and in the case that the access is not allowed, directly returns the failure response, thereby avoiding unnecessary signaling load.

It is appreciated to persons ordinarily skilled in the art that all or a part of steps that implement the methods in the above embodiments can be performed by relevant hardware instructed by a program, and the program can be stored in a computer readable storage medium. The storage medium may be a read-only memory, a magnetic disk, or an optical disk, and the like.

The above are merely preferred embodiments of the present disclosure, and are not restrictive of the present disclosure. To those skilled in the art, the present disclosure may include various modifications and variations. All modifications, equivalent substitutions and improvements made within the spirit and principle of the present disclosure shall be covered by the claims of the present disclosure.

1. A method for managing user access to a network, comprising:
receiving a location update request carrying a radio access type currently used by a user sent from a mobile management apparatus;
determining, in accordance with the radio access type currently used by the user, whether the user is allowed to access a network through the currently used radio access type; and
returning a location update failure response if the user is not allowed to access the network.

2. The method according to claim 1, wherein:
the radio access type currently used by the user is indicated by a newly added access type parameter of the location update request.

3. The method according to claim 1, wherein the location update failure response carries an access restriction indicator.

4. The method according to claim 3, wherein the access restriction indicator carried in the location update failure response is one of “Roaming not Allowed due to Access Restriction” and a newly defined failure indicator “Access Type not Allowed.”

5. The method according to claim 1, wherein the receiving the location update request carrying the radio access type currently used by the user sent from the mobile management apparatus comprises:
receiving, by one of a home location register (HLR) and a home subscriber server (HSS), the location update request carrying the radio access type currently used by the user sent from the mobile management apparatus;
and
the determining, in accordance with the radio access type currently used by the user, whether the user is allowed to access the network through the currently used radio access type comprises:
checking, by the one of the HLR and the HSS, in accordance with the received radio access type currently used by the user, access restriction subscription data in user subscription data stored therein to determine whether the user is allowed to access the network through the currently used radio access type.

6. The method according to claim 1, wherein the receiving the location update request carrying the radio access type currently used by the user sent from the mobile management apparatus comprises:
receiving, by an inter-working function (IWF), the location update request based on a Diameter protocol carrying the radio access type currently used by the user sent from the mobile management apparatus;
and
the determining, in accordance with the radio access type currently used by the user, whether the user is allowed to access the network through the currently used radio access type comprises:
determining, by the IWF, whether it has stored access restriction subscription data of the user concerning the currently used radio access type; and
determining, by the IWF, if the IWF has stored the access restriction subscription data of the user concerning the currently used radio access type, whether the user is allowed to access the network through the currently used radio access type.

7. The method according to claim 6, wherein, if the IWF judges that the IWF has not stored the access restriction subscription data of the user concerning the currently used radio access type, the IWF converts the location update request carrying the radio access type currently used by the user into a location update request based on an MAP protocol, and forwards the converted location update request to the one of the HLR and the HSS; and
the one of the HLR and the HSS determines whether the user is allowed to access the network through the currently used radio access type in accordance with the received location update request.

8. The method according to claim 1, further comprising:
obtaining user subscription data and returning the obtained user subscription data to the mobile management apparatus if it is determined that the user is allowed to access the network through the currently used radio access type.

9. The method according to claim 8, wherein the obtaining the user subscription data comprises:
obtaining, by one of an HLR and an HSS, the user subscription data stored therein if whether the user is allowed to access the network through the currently used radio access type is determined by the one of the HLR and the HSS; and
forwarding, by an IWF, the location update request to the one of the HLR and the HSS and obtaining the user subscription data from the one of the HLR and the HSS, if whether the user is allowed to access the network through the currently used radio access type is determined by the IWF.

10. An access restriction management apparatus, comprising:
a request receiving unit, adapted to receive a location update request carrying a radio access type currently used by a user sent from a mobile management apparatus;
a storing unit, adapted to store access restriction subscription data of the user;
a managing unit, adapted to: check the access restriction subscription data of the user stored in the storing unit in accordance with the radio access type currently used by the user as received by the request receiving unit, and determine whether the user is allowed to access a network through the currently used radio access type; and
a first processing unit, adapted to return a location update failure response to the mobile management apparatus when the managing unit determines that the user is not allowed to access the network through the currently used radio access type.

11. The apparatus according to claim 10, wherein the storing unit is further adapted to store subscription data of the user, and the apparatus further comprises:
a second processing unit, adapted to: obtain the subscription data of the user stored in the storing unit, and return the obtained subscription data to the mobile management apparatus in the case where the managing unit determines that the user is allowed to access the network through the currently used radio access type.

12. The apparatus according to claim 10, further comprising:
a judging unit, adapted to judge whether the storing unit has stored access restriction subscription data of the user concerning the currently used radio access type;
wherein the managing unit determines, when the judging unit judges that the storing unit has stored the access restriction subscription data of the user concerning the currently used radio access type, whether the user is allowed to access the network through the currently used radio access type.

13. The apparatus according to claim 12, further comprising:
a third processing unit, adapted to forward the location update request carrying the radio access type currently used by the user as received by the request receiving unit to one of an HLR and an HSS when the managing unit determines that the user is allowed to access the network through the currently used radio access type, or when the judging unit judges that the storing unit has not stored the access restriction subscription data of the user concerning the currently used radio access type.

14. The apparatus according to claim 13, further comprising:
a forwarding unit, adapted to forward one of a received subscription data of the user and a location update failure response to the mobile management apparatus, wherein the one of the received subscription data of the user and the location update failure response is transmitted after the one of the HLR and the HSS has determined whether the user is allowed to access the network through the currently used radio access type in accordance with the radio access type currently used by the user as forwarded by the third processing unit.

15. A communication system for executing location update, comprising:
a mobile management apparatus, adapted to transmit a location update request carrying a radio access type currently used by a user; and
one of a home location register (HLR) and a home subscriber server (HSS), adapted to: receive the location update request carrying the radio access type currently used by the user; determine, in accordance with the radio access type currently used by the user, whether the user is allowed to access a network through the currently used radio access type; and return a location update failure response if the user is not allowed to access the network.

16. A communication system for executing location update, comprising:
a mobile management apparatus, adapted to transmit a location update request carrying a radio access type currently used by a user; and
an inter-working function (IWF), adapted to determine whether the user is allowed to access a network through the currently used radio access type when the IWF judges that the IWF has stored access restriction subscription data of the user concerning the currently used radio access type, and return a location update failure response if the user is not allowed to access the network.

17. The system according to claim 16, wherein the IWF is further adapted to forward the location update request carrying the radio access type currently used by the user when it judges that it has not stored the access restriction subscription data of the user concerning the currently used radio access type,
and
the system further comprises:
one of a home location register (HLR) and a home subscriber server (HSS), adapted to: receive the location update request carrying the radio access type currently used by the user as forwarded by the IWF; determine, in accordance with the radio access type currently used by the user, whether the user is allowed to access the network through the currently used radio access type; and return a location update failure response if the user is not allowed to access the network.

18. The method according to claim 5, further comprising:
obtaining user subscription data and returning the obtained user subscription data to the mobile management apparatus if it is determined that the user is allowed to access the network through the currently used radio access type.

19. The method according to claim 6, further comprising:
obtaining user subscription data and returning the obtained user subscription data to the mobile management apparatus if it is determined that the user is allowed to access the network through the currently used radio access type.

20. The method according to claim 7, further comprising:
obtaining user subscription data and returning the obtained user subscription data to the mobile management apparatus if it is determined that the user is allowed to access the network through the currently used radio access type.
This listing of claims replaces all prior versions, and listings, of claims in the application.
